(19) United States
(12) Patent Application Publication
(10) Pub. No.: US 2017/0306766 A1
(43) Pub. Date: Oct. 26, 2017

(54) TURBINE BLADE HAVING AN INNER MODULE AND METHOD FOR PRODUCING A TURBINE BLADE

(71) Applicant: Siemens Aktiengesellschaft, Munich (DE)

(72) Inventor: Jan Münzer, Berlin (DE)

(73) Assignee: Siemens Aktiengesellschaft, Munich (DE)

(21) Appl. No.: 15/517,756

(22) PCT Filed: Oct. 8, 2015
(86) PCT No.: PCT/EP2015/073258

§ 371 Date: Apr. 7, 2017

(30) Foreign Application Priority Data
Oct. 14, 2014 (DE) 10 2014 220 787.8

(51) Int. Cl. F01D 5/18; B33Y 80/00; B23K 26/342; F01D 5/28; B33Y 10/00; B22D 18/06; B22F 5/00; B22C 9/04; B23K 101/00

(52) U.S. Cl. CPC F01D 5/187; B22F 5/007; B33Y 80/00; B23K 26/342; B22C 9/04; F01D 5/28; B33Y 10/00; B22D 18/06; B23K 2201/001; F05D 2220/32; F05D 2230/31; F05D 2260/202

(57) ABSTRACT

A turbine blade having a casing and having an inner module, wherein a cooling medium can flow through the inner module both in a longitudinal direction and in a radial direction, and the inner module is attached to the casing by fixed bearings and floating bearings. A method for producing a turbine blade having an inner module and having a casing is produced by selective laser melting.

### CROSS REFERENCE TO RELATED APPLICATIONS

This application is the US National Stage of International Application No. PCT/EP2015/073258 filed 8 Oct. 2015, and claims the benefit thereof. The International Application claims the benefit of German Application No. DE 102014220787.8 filed 14 Oct. 2014. All of the applications are incorporated by reference herein in their entirety.

### FIELD OF INVENTION

The invention relates to a turbine blade having an inner module, and to a method for producing said turbine blade by means of selective laser melting.

### BACKGROUND OF INVENTION

Gas turbines are used as power machines for various installations, for example in power plants, in jet engines and similar gas turbine components, in particular turbine guide and rotor blades, though ring segments or components from the region of the combustion chamber are also exposed to high thermal and mechanical loads during the operation thereof. For this reason, they are commonly cooled using compressor air and, in the case of the combustion chamber, also with unburned fuel. Water vapor is in some cases also used for cooling.

Turbine blades generally form a cavity formed by their outer shell, also referred to as casing, wherein said cavity is commonly divided by side walls. For cooling, the components are, for example in an interior space formed by the side walls, flowed through by the cooling medium, wherein heat is extracted from the component in the interior, and the component is thus actively cooled. For this purpose, it is for example the case that cooling air from the interior space is conducted through so-called impingement ducts into an intermediate space between the interior space and the casing, and impinges there on the inner side of the thermally highly loaded casing. The technology in this application is intended in particular for cooling air as cooling medium. Therefore, below, the expression “cooling air” will be used, but without this ruling out other cooling media.

Subsequently, the cooling air is commonly blown out through bores in the casing. Here, the cooling air discharges heat from the interior and/or the component wall and furthermore forms a film on the blade surface, which forms as an insulating layer between the blade surface and the hot gas.

In present embodiments of gas turbines, in the interests of effective cooling, disadvantages are also accepted with regard to costs, component service life, efficiency and power. For example, in turbine rotor blades, an inner geometry designed for mechanical integrity and cooling air guidance is generated by means of the shape of a core in a vacuum precision casting process. Here, for example by means of microsystem technology, it has been possible for the cores and thus the subsequent component to be made even more complex, more stable and more precise in the microscopic range. In the case of turbine guide blades, the inner geometry is often realized not only by a replication of the casting core but also by means of cooling air inserts, generally so-called impingement cooling sets. Cutting-edge technology in this field includes the so-called Spar-Shell technology from Florida Turbine Technologies.

The prior art solutions however have certain disadvantages. Conventional core production processes for turbine blades are limited with regard to core geometry complexity, core stability, geometry part resolution and with regard to other criteria. Micro-cores are also subject to limits in the design process with the aim of optimization, in particular with regard to the dimensions and the stability of the complex ceramic cores during the manufacturing process. The production process is also relatively expensive owing to the high reject rate. In the case of rotor blades with cores from conventional microprocesses, the cooling air flow runs primarily in a radial direction, which limits optimum utilization of the cooling air potential, specifically from the aspect that, with increased local heat transfer, there is often a need for a general increase in the cooling air mass flow of the blades in order to be able to dissipate the heat from the component too. In particular in the case of rotor blades but also in the case of guide blades of turbines, the problem often arises that stresses arising in the component as a result of thermal loading, on the one hand, and as a result of effective cooling, on the other hand, reduce service life, or the design is limited because, in the component, there are regions in which very hot regions, for example outer walls, adjoin very cold regions, for example very intensely cooled inner walls, because the turbine rotor blades produced by means of conventional cores or micro-cores form an integral component also composed of matching, similar materials. It has hitherto not been possible, from a manufacturing aspect, to implement approaches for thermally insulating certain regions, for example by means of local ceramic inner coatings, and thus at least partially solving the problem.

Furthermore, in the case of turbine guide blades, the problem arises that the cooling air supply pressure there is generally equally high in all regions of a component, which is not necessary. An excessive amount of cooling potential is lost in this way, and expensive compressor air is used for cooling. Spar-Shell technology offers advantages here, with regard to the cooling air utilization and thus efficiency, owing to the fact that the cooling air flows through the component not only radially but also in and counter to the flow direction. However, the production of the cooling inserts (Spar) is highly cumbersome and thus expensive, and is also limited in terms of its complexity from a manufacturing aspect. Furthermore, the subsequent insertion into the component (shell) is likewise cumbersome, and the component design is restricted by existing joining technologies in component design owing to the need for insertability into the component before the joining or during the installation.

### SUMMARY OF INVENTION

It is thus an object to provide a turbine blade having an insert which ensures optimum cooling, which insert is complex, stable and at the same time easy to produce. It is furthermore the object to provide a method with which a turbine blade having a corresponding insert can be produced. The first object is achieved by means of a turbine blade having the features of the independent claim. The second object is achieved by means of a method having the features of the independent claim. Further advantageous variants and refinements of the invention will emerge from the subclaims, from the exemplary embodiments and from the figures.

A first aspect of the invention relates to a turbine blade having a casing and having an inner module adapted to the shape of the casing, wherein the inner module comprises an interior space, through which flow can pass in a longitudinal direction of the inner module and which has an inflow opening, and a wall, which has a number of ducts through which flow can pass in a radial direction and which connect an inner side to an outer side of the wall of the inner module, in which turbine blade a peripheral intermediate space is provided between the outer side of the wall of the inner module and an inner side of the casing, and a number of perforations is provided between the inner side and an outer side of the casing at a certain angle of inclination relative to the outer side of the casing, characterized in that the outer side of the inner module is connected by means of at least one fixed bearing and at least one floating bearing to the inner side of the casing.

The component according to the invention can be designed such that cooling air can flow through it both in a longitudinal direction and in a radial direction. The cooling air passes through fine ducts into the peripheral intermediate space and, there, impinges in accurately measured fashion as impinging cooling air on the inner side of the casing of the turbine blade. Subsequently, the air flows through perforations in the casing to the outer side of the casing, where a film forms and further convective heat dissipation occurs. The turbine blade according to the invention is advantageous because it permits not only the optimized internal cooling of the blade utilizing the cooling potential of the cooling air but also the implementation of lightweight structures, because the cooling and structural functions can be decoupled. The modular design of the component and the use of different materials for casing and inner module have an advantageous effect on thermal stresses in the component.

The advantage of the configuration of at least one connection of the inner module to the casing of the turbine blade as a floating bearing at some locations consists in particular in the avoidance of static overdeterminacy in the integration of the inner module into the turbine blade. Furthermore, this configuration permits free thermal or centrifugal-force-induced expansion in a primarily radial direction. It permits compensation of manufacturing and joining tolerances, facilitates the positioning of the inner module in the blade and promotes vibration damping.

The advantage of the configuration of at least one connection of the inner module to the casing as a fixed bearing serves in particular for the accommodation of loads in the inner module in the component. The connection between the inner module and the turbine blade is realized in particular by the supporting profiles of the inner module. It is thus advantageous for supporting profiles to be formed on the outer side of the wall of the inner module. Said supporting profiles typically have a supporting flank and a free flank. The connection of casing and inner module by means of a fixed bearing is advantageous because, in this way, the remaining degrees of freedom can be defined, in particular in the radial direction. The fixed bearing also serves for the accommodation of loads (centrifugal force), for damping and for the positioning of the inner module in the blade.

It is advantageous if the material of the inner module is a metal. This may ideally be an alloy or a superalloy. It may be the same material as that of the casing of the turbine blade, though may also differ from this. A metal advantageously permits a metallurgical connection between inner module and the casing of the turbine blade, which is typically likewise manufactured from metal, ideally an alloy or a superalloy.

In a further embodiment, the casing and the inner module are metallurgically connected. This may be realized for example by means of a melting-together process during the casting process of the turbine blade. It is however likewise advantageous if the inner module and the casing of the turbine blade are connected in positively locking fashion or non-positively locking fashion by means of the fixed bearing.

The angles of inclination of the perforations in the casing of the turbine blade relative to the outer side of the casing are advantageously configured such that a film can be formed on the outer side of the casing by the air flowing out via the perforations. The formation of a film is advantageous because it effects cooling on the outer side of the casing and thus on the surface of the turbine blade.

The interior space of the inner module is advantageously divided into at least two chambers which are connected to one another by means of in each case at least one opening through which flow can pass. The division into chambers serves inter alia for the stability of the inner volume.

Furthermore, the inner module advantageously has additional ducts in its wall in the distal wall, that is to say in the wall in the region of the turbine blade tip. Flow passes through said additional ducts not in a radial direction of the inner module or of the turbine blade but in a longitudinal direction. Said ducts are likewise provided for impingement cooling.

It is particularly advantageous if the inner module of the turbine blade is generated by selective laser melting. By means of selective laser melting, it is possible owing to the possibilities of the process of selective melting, in particular by way of the layer-by-layer construction, for the inner module to be relatively easily configured with a complex and stable structure such that cooling air can flow through it both in a radial direction and in the flow direction. The advantage of such inner modules lies in the fact that they can be of complex design but can at the same time be designed optimally. In particular in conjunction with a ceramic set-up core for component production of the turbine blade, the realization of components by means of selective laser melting is particularly advantageous.

A second aspect of the invention relates to a method for producing a turbine blade, which method comprises the following steps S1 to S5 for generating an inner module:
S1) providing a building platform in a powder bed,
S2) applying a powder material in a certain quantity,
S3) distributing the material over the building platform,
S4) locally melting powder particles by means of the action of a laser beam,
S5) lowering the platform.

During the local melting of powder particles, the powder particles are also melted together with a layer situated underneath. Here, steps S2 to S5 are repeated as many times as necessary to complete the manufacture of the inner module. The method for production by means of selective laser melting is advantageous because it is a mold-free manufacturing process, and thus no tools or molds are required. Furthermore, the method is advantageous because a large degree of geometrical freedom is realized, which permits component shapes which cannot be produced, or can be produced only with great effort, using mold-based methods. Thus, owing to the possibilities of said process, the inner module can, in particular with regard to complex structures, be designed such that cooling air can flow through it both in a radial direction and in the flow direction, and said cooling air can, in accurately measured fashion at the corresponding points, be conducted as impinging cooling air through fine ducts to the inner side of the casing. Furthermore, the production process makes it possible to produce complex structures in the outer side, which structures permit the fastening of the inner module to the casing by means of fixed and floating bearings. Here, it is particularly advantageous if the powder material has a metal. It is furthermore advantageous if the powder material is a metal, and it is likewise advantageous if the powder material is a metal alloy. This is advantageous because, in this way, a metallurgical connection between the inner module and the casing of the turbine blade, which is typically likewise composed of metal, is possible.

It is furthermore advantageous if, during the selective laser melting process, supporting profiles are generated in the outer side of the inner module. The supporting profiles have supporting flanks and free flanks. By means of said supporting profiles, a fastening of the inner module to the casing is possible.

The method according to the invention furthermore comprises the following steps S6 to S10 for generating a casing of the turbine blade, which steps follow step S4 of the production of the inner module when the manufacture thereof is complete:
S6) applying a ceramic casting core around the inner module, wherein the supporting and free flanks at at least one supporting profile provided for a fixed bearing are not encased by a ceramic core material,
S7) embedding the ceramic casting core, which comprises the inner module, into a wax model of the blade,
S8) producing a casting mold for the casing from a wax model,
S9) stabilizing the casting core in the casting mold by fixing by means of ceramic and/or metallic pins,
S10) casting the metal mold.

The supporting profile which is not encased by the ceramic core material is intended, during the casting of the casing, to form the fixed bearing by means of which the inner module is connected to the casing of the turbine blade. The tip of the supporting profiles is thus left metallically blank in order to provide the requirement for a positively locking or in particular metallurgical connection between inner module and casing.

It is advantageous if the outer side of the inner module is connected to the inner side of the casing by mechanical positive locking. This is made possible by the formation of the supporting profiles by means of selective laser melting and the casting mold of the casing with the corresponding positively locking structures, that is to say corresponding recesses.

It is furthermore advantageous if the outer side of the inner module is metallurgically connected to the inner side of the casing. This is likewise made possible by the formation of the supporting profile by means of selective laser melting and the casting mold of the casing. During the casting of the casing, a metallurgical connection is formed in the region of the supporting profile owing to the high temperatures of the hot metal.

In the present invention, an inner module refers to an insert for turbine blades. The term “inner module” emphasizes the modular design.

The inner side of the inner module refers to the inwardly directed surface of said inner module, which surface delimits the interior space of the inner module.

The outer side of the inner module refers to the outwardly directed surface of said inner module, which surface is situated opposite the inner side of the casing in a radial direction and forms an inner delimitation of the peripheral intermediate space.

The inner side of the casing refers to the inwardly directed surface of said casing, which surface delimits the peripheral intermediate space to the outside in a radial direction.

The outer side of the casing refers to that surface of said casing which is directed outward in a radial direction, which surface can also be referred to as outer side or surface of the casing or of the turbine blade.

A fixed bearing is a so-called immovable bearing which prevents all translational movements of the mounted body, in the present application of the inner module. No torques are transmitted, and the inner module is fixedly mounted in three spatial directions.

A floating bearing prevents only one or two translational movements and permits the others. Correspondingly, in at least one or two directions, there is no fixed connection to or between the inner module and casing.

The longitudinal direction of the inner module and that of the turbine blade oriented in the same direction, and of the casing of the turbine blade, refers to the extent of the turbine blade from the root section of the turbine blade, where said turbine blade is fastened to the turbine rotor, to the tip of the turbine rotor blade.

The radial direction is oriented outward perpendicular to the longitudinal direction.

### BRIEF DESCRIPTION OF THE DRAWINGS

The invention will be discussed in more detail on the basis of the figures, in which:

FIG. 1 shows a longitudinal section through an exemplary embodiment of a turbine blade, with an illustration of the inner geometry of an inner module and of a casing of the turbine blade.

FIG. 2 shows a longitudinal section through a section of the turbine blade as per FIG. 1.

FIG. 3 shows a longitudinal section through a section of the turbine blade as per FIG. 1.

FIG. 4 shows a longitudinal section through a section of the turbine blade as per FIG. 1.

FIG. 5 shows a longitudinal section through a device for producing the inner module of the turbine blade as per FIG. 1.

FIG. 6 shows a longitudinal section through the inner module of the turbine blade as per FIG. 1.

FIG. 7 is an illustration of a wax mold for the production of the casing of the turbine blade as per FIG. 1.

FIG. 8 shows a flow diagram of an exemplary embodiment of a method for the production of the turbine blade as per FIG. 1.

### DETAILED DESCRIPTION OF INVENTION

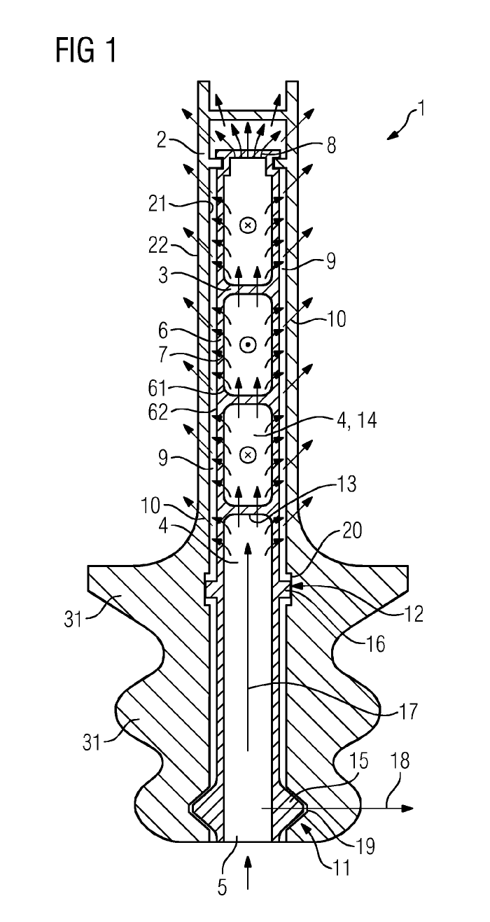

In the embodiment illustrated by way of example in FIG. 1, the turbine blade 1 comprises a casing 2 and an inner module 3. The inner module 3 is adapted substantially to the shape of the casing 2. The inner module 3 has an interior space 4 through which flow can pass in a longitudinal direction 17 of the inner module 3 and which has an inflow opening 5 and a wall 6 with a number of ducts 7, through which ducts flow can pass in a radial direction 18 and which ducts connect an inner side 61 to an outer side 62 of the wall 6 of the inner module 3. Furthermore, the illustrated inner module 3 has, in the distal region of the wall 6, a number of ducts 8 through which flow can pass in the longitudinal direction 17, which ducts are in this case arranged in addition to the ducts 7, through which flow can pass in the radial direction, in the lateral region of the wall 6.

Between the inner module 3 and casing 2 there is provided a peripheral intermediate space 9 which is delimited by the outer side 62 of the inner module 3 and the inner side 21 of the casing 2. Through the ducts 7 and 8, cooling air can flow out of the inner space 4 into the peripheral intermediate space 9, where it can impinge on the inner side 21 of the casing 2 and thereby impart the effect of impingement cooling. In the casing 2 there is arranged a number of perforations 10 through which the cooling air can flow out of the intermediate space 9 to the outer side 22 of the casing 2, where said cooling air can form a cooling film.

The inner module 3 is connected to the casing 2 by means of fixed bearings 11 and floating bearings 12. Here, in each case at least one bearing is provided, though it is advantageous for multiple fixed bearings 11 and multiple floating bearings 12 to be provided for the connection of inner module 3 and casing 2. For the connection by means of fixed bearings 11, the inner module 3 has at least one supporting profile 15, and for the connection by means of floating bearings 12, the inner module has at least one supporting profile 16, wherein the number of supporting profiles 15 and 16 is configured in accordance with the length of the turbine blade 1 and accordingly of the inner module 3. At the locations of the fixed bearings 11 that are provided, the casing 2 has recesses 19 corresponding to the supporting profiles 15, and at the locations of the floating bearings 12 that are provided, the casing has recesses 20 corresponding to the supporting profiles 16.

The supporting profiles 15 and 16 and the recesses 19 and 20 advantageously run in ring-shaped fashion around an entire region around the outer side 62 of the inner module 3 or the inner side 21 of the casing 2, though may also be arranged only at individual locations. The fixed bearings 11 and floating bearings 12 accordingly advantageously run in closed ring-shaped form, though may also be arranged only at individual locations.

The fixed bearings 11 interrupt the peripheral intermediate space 9 as they run around the entire outer side 62 of the inner module 3 and, here, are impermeable to cooling air owing to positive locking or metallurgical connection to the inner side 21 of the casing 2. The floating bearings 12 interrupt the peripheral intermediate space 9 if they run in a region around the outer side 62 of the inner module 3 and, here, abut firmly against a region of the inner side 21 of the casing 2.

The interior space 4 of the inner module 3 is composed of multiple chambers 14 which are separated by the material of the inner module 3 and which are connected to one another by means of openings 13 through which flow can pass in a longitudinal direction. Here, the inner module 3 advantageously has 2 chambers 14, likewise advantageously 3, likewise advantageously 4, and likewise advantageously 5 and more.

At the root end, the turbine blade 1 has a fir-tree-shaped structure 31 which serves for the stable connection to the turbine rotor (not shown) by means of a correspondingly designed structure.

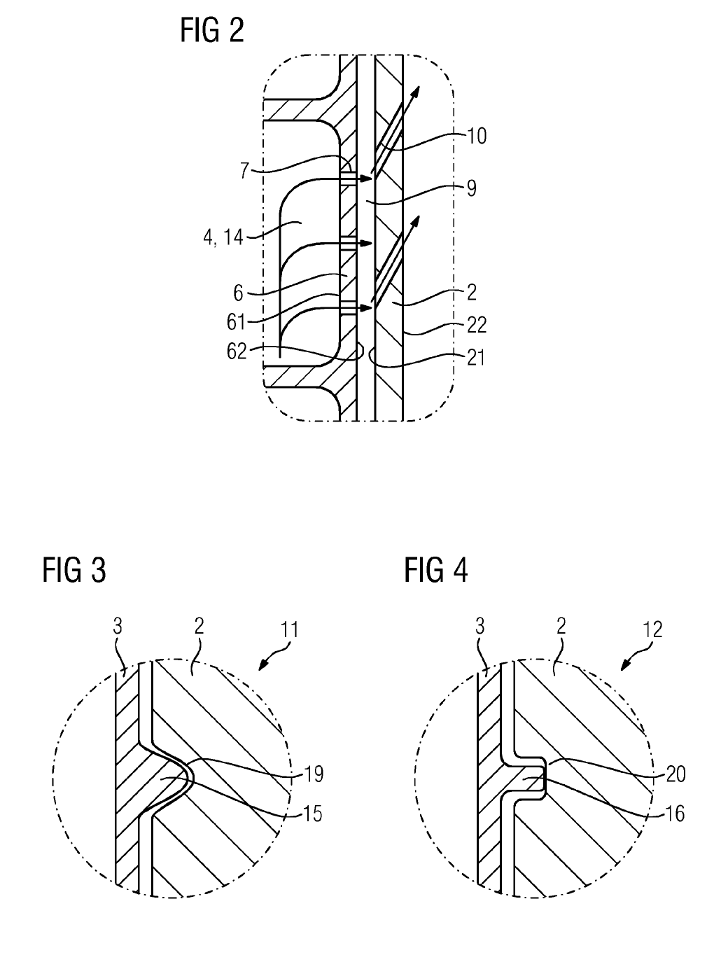

The peripheral intermediate space 9 essential for the cooling of the turbine blade 1 is formed between the outer side 61 of the wall 6 of the inner module 3 and the inner side 21 of the casing 2, as illustrated in FIG. 2. Here, the ducts 7 are formed such that, from the interior space 4, cooling air can flow in a radial direction 18 through the ducts 7 into the peripheral intermediate space 9, where said cooling air impinges on the inner side 21 of the casing 2. The perforations 10 in the casing 2 are configured, in terms of number and angle of inclination, such that cooling air flowing through the perforations from the peripheral intermediate space 9 to the outer side 22 of the casing 2 can form a cooling film there. The angle of inclination of the perforations relative to the outer side 22 is between 10 and 80 degrees, advantageously between 20 and 70 degrees, more advantageously between 30 and 60 degrees, even more advantageously between 40 and 50 degrees, and is even more advantageously 45 degrees.

The connection of the inner module 3 to the casing 2 by means of fixed bearings 11 is illustrated in detail in FIG. 3. The supporting profile 15 of the inner module 3 and the corresponding recess 19 in the casing 2 are dimensionally coordinated with one another so as to fit with one another in positively locking fashion. Owing to the complete positive locking thereby effected, the inner module 3 is not movable in any direction at the location of the fixed bearing 11.

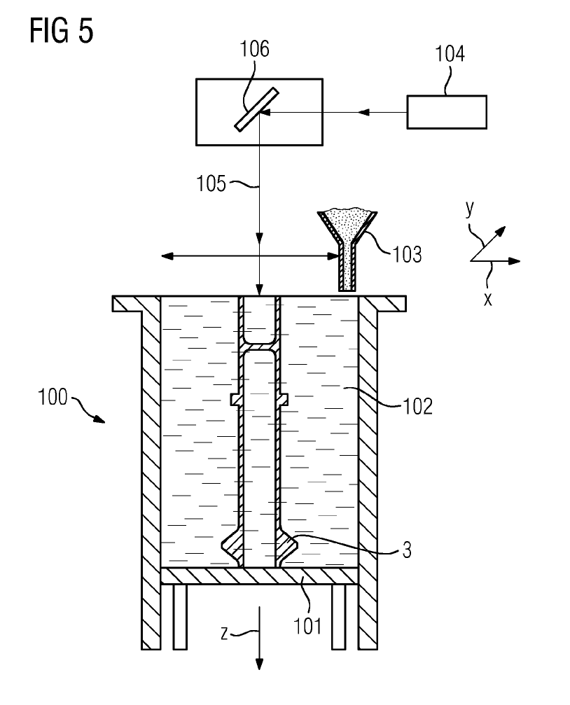

The connection of the inner module 3 to the casing 2 by means of floating bearings 12 is illustrated in detail in FIG. 4. The supporting profile 16 of the inner module 3 and the corresponding recess 20 in the casing 2 are dimensionally coordinated with one another, but allow degrees of freedom, that is to say a certain mobility or a certain clearance of the supporting profile 16 within the recess 20.

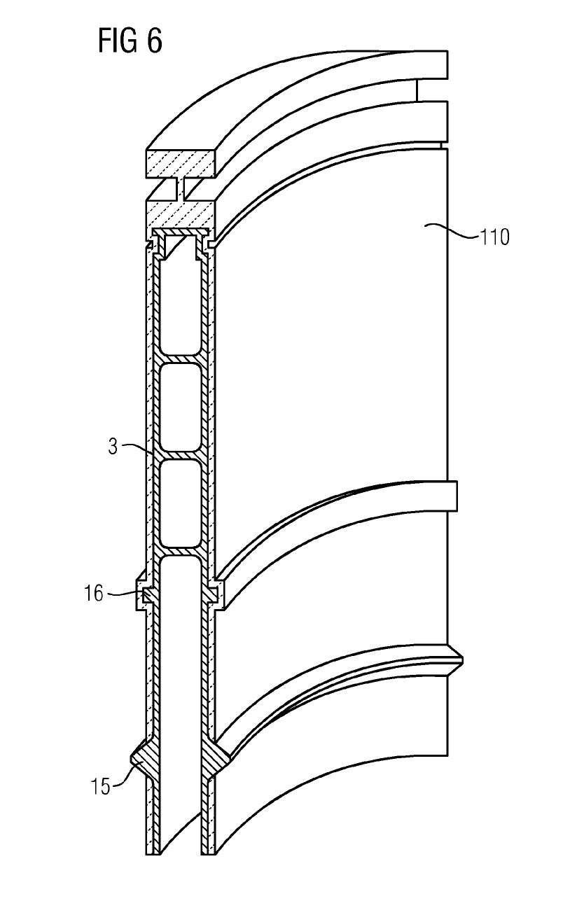

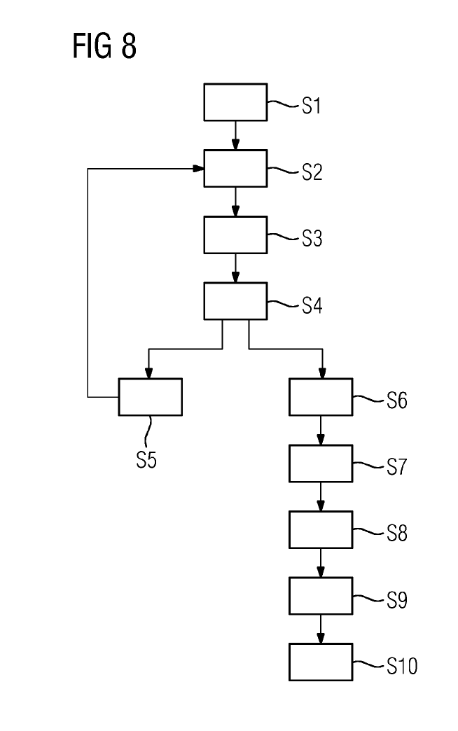

The production of the inner module 3 of the turbine blade 1 is performed, as per the steps of the flow diagram in FIG. 8, in a melt bath 100. In step S1, as per FIG. 5, a building platform 101 is provided. In step S2, a powder material 102, advantageously composed of a metal or of a metal alloy, for example composed of the same material as the turbine blade, but optionally also composed of a different material, is applied in a certain quantity to the building platform 101 by means of the filling device 103. In step S3, the applied material 102 is distributed on the building platform 101, for example by means of a slide or a wiper, so as to form a layer of a thickness which can be easily melted, correspondingly to the desired structure, by means of laser beams 105. Advantageous layer thicknesses are in this case 20-100 μm.

In step S4, local melting of the powder particles 103 is effected by means of the action of a laser beam 105 which is generated by means of a laser 104 and which, by means of a rotating mirror 106, is guided over the building platform 101 in software-controlled fashion such that the desired solid structures are realized, for example the supporting profiles 15 and 16. The powder material 102 is fully re-melted at the locations of the laser radiation, and after solidifying, forms a solid material layer.

After step S4, it is checked whether the manufacture of the inner module is complete. If it is incomplete, then in step S5, the building platform 101 is lowered by the height corresponding to a layer thickness, and the process is started again from step S2. The cycle of steps S2-S5 is repeated until the manufacture of the inner module 3 in the desired structure is complete.

If, in step S4, it is identified that the manufacture of the inner module is complete, then following this step, in step S6, a ceramic casting core 110 is generated around the inner module 3. Here, conventional ceramic material is used for the casting core. Here, as can be seen in FIG. 6, the supporting profiles 15 provided for forming fixed bearings 11 are not encased by ceramic. By contrast, the supporting profiles 16 provided for forming floating bearings 12 are encased by ceramic.

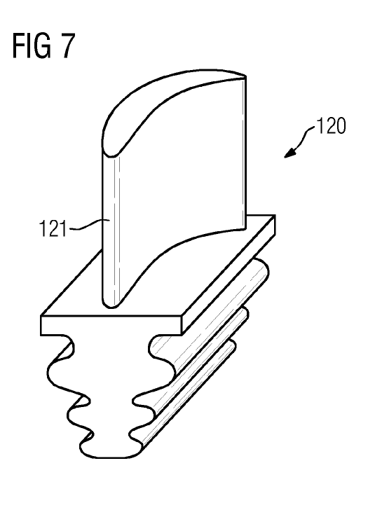

In step S7, the ceramic casting core 110 containing the inner module 3 is embedded into a wax model 120 of the turbine blade 1, in which said casting core is surrounded by wax 121, as illustrated in FIG. 7. Then, in step S8, a casting mold, the so-called casting shell, for the casing 2 is produced. In step S9, the ceramic core 110 with inner module 3 is stabilized in the casting shell by means of ceramic and/or metallic pins.

In step S10, the mold of the casing 2 is cast. Here, a region of the ceramic casting core 110 forms the peripheral intermediate space 9 between inner module 3 and casing 2. As material of the casing 2, use is made for example of metals, advantageously alloys and superalloys. By means of the positively locking configuration of the supporting profiles 15 and the corresponding recesses 19, the outer side 62 of the inner module 3 is connected to the inner side 21 of the casing 2 in the region of the fixed bearings 11 advantageously by mechanical positive locking.

Owing to the positively locking configuration of the supporting profiles 15 and of the corresponding recesses 19 and owing to the advantageous metal of the powder material 102, the outer side 62 of the inner module 3 is connected to the inner side 21 of the casing 2 in the region of the fixed bearings 11 likewise advantageously by means of a metallurgical connection. The metallurgical connection is in this case made possible by the high temperatures of the liquid metal of the casing 2, which effect melting of exposed regions of the inner module.

Modifications and alterations to the invention that are obvious to a person skilled in the art fall within the scope of protection of the patent claims.

1.-15. (canceled)

16. A turbine rotor blade, comprising:
a casing and an inner module adapted to the shape of the casing,
wherein the inner module comprises an interior space, through which flow can pass in a longitudinal direction and which has an inflow opening, and a wall, which has a number of ducts through which flow can pass in a radial direction and which connect an inner side to an outer side of the wall of the inner module,
wherein in the turbine rotor blade a peripheral intermediate space is provided between the outer side of the wall of the inner module and an inner side of the casing, and a number of perforations is provided between the inner side and an outer side of the casing at a certain angle of inclination relative to the outer side of the casing,
wherein the outer side of the inner module is connected by at least one fixed bearing and at least one floating bearing to the inner side of the casing.

17. The turbine rotor blade as claimed in claim 16, further comprising:
supporting profiles on the outer side of the wall of the inner module.

18. The turbine rotor blade as claimed in claim 16,
wherein the material of the inner module is a metal.

19. The turbine rotor blade as claimed in claim 16,
wherein the inner module and casing are metallurgically connected.

20. The turbine rotor blade as claimed in claim 16,
wherein the inner module and casing are connected in positively locking fashion by the fixed bearing.

21. The turbine rotor blade as claimed in claim 16,
wherein the angles of inclination of the perforations in the casing relative to the outer side of the casing are configured such that a film is formable on the outer side of the casing by the air flowing out via the perforations.

22. The turbine rotor blade as claimed in claim 16,
wherein the interior space of the inner module is divided into at least two chambers which are connected to one another by, in each case, at least one opening through which flow can pass.

23. The turbine rotor blade as claimed in claim 16,
wherein ducts through which flow can pass in the longitudinal direction of the inner module are additionally arranged in the distal wall of the inner module.

24. The turbine rotor blade as claimed in claim 16,
wherein the inner module is generated by selective laser melting.

25. A method for producing a turbine rotor blade as claimed in claim 16, wherein the steps for generating an inner module comprise:
S1) providing a building platform in a powder bed,
S2) applying a powder material in a certain quantity,
S3) distributing the material over the building platform,
S4) locally melting powder particles by means of the action of a laser beam,
S5) lowering the platform,
wherein steps S2-S5 are repeated as many times as necessary to complete the manufacture of the inner module, and wherein the method subsequently additionally comprises:
S6) applying a ceramic casting core around the inner module, wherein the supporting and free flanks at at least one supporting profile provided for a fixed bearing are not encased by a ceramic core material,
S7) embedding the ceramic casting core, which comprises the inner module, into a wax model of the blade,
S8) producing a casting mold for the casing from the wax model,
S9) stabilizing the casting core in the casting mold by fixing by means of ceramic and/or metallic pins, and
S10) casting the casing mold.

26. The method as claimed in claim 25,
wherein the powder material has a metal.

27. The method as claimed in claim 25,
wherein supporting profiles are generated in the outer side of the inner module.

28. The method as claimed in claim 25,
wherein the outer side of the inner module is connected to the inner side of the casing in the region of the fixed bearing by mechanical positive locking.

29. The method as claimed in claim 25,
wherein the outer side of the inner module is metallurgically connected to the inner side of the casing in the region of the fixed bearing.
